(19) United States
(12) Patent Application Publication
(10) Pub. No.: US 2020/0215715 A1
(43) Pub. Date: Jul. 9, 2020

(54) Handheld Workpiece Milling Device with Error Self-correction Based on Augmented Reality Technology

(71) Applicant: William Wing-Chung TAM, Hong kong (HK)

(72) Inventor: William Wing-Chung TAM, Hong kong (HK)

(21) Appl. No.: 16/296,136

(22) Filed: Mar. 7, 2019

(30) Foreign Application Priority Data
Jan. 9, 2019 (CN) 201910020509.5

(51) Int. Cl. B27C 5/10; B23Q 17/22; B23Q 17/24; B25H 1/00

(52) U.S. Cl. CPC B27C 5/10; B23Q 17/2233; B25H 1/0092; B23Q 17/249; B23Q 17/2404

(57) ABSTRACT

The invention relates to a handheld workpiece milling device with error self-correction based on augmented reality technology which includes a base, a control box, a milling mechanism, a control handle, and a direction and distance detecting mechanism. The base is provided with a transparent plate, a through groove, a screw hole, and a support platform. The controller, the battery and the display are arranged in the control box from bottom to top. The milling mechanism includes a housing, a motor, a rolling drum and a support rod 34. The control handle is respectively provided with a plurality of control buttons. The direction and distance detecting mechanism includes a first [symbol] -shaped plate, an angle sensor, a tension spring, and a second [symbol] -shaped plate, and a roller. The handheld workpiece milling device with error self-correction based on augmented reality technology has a reasonable structure, simple structure, convenient to use and high intelligence, high precision, small volume and strong practicability, and effectively solves the problem of low precision of the existing hand-held processing machine.

### FIELD OF THE INVENTION

The invention relates to the field of processing machinery and equipment, and in particular to a handheld workpiece milling device with error self-correction based on augmented reality technology.

### BACKGROUND

In the prior art, the cutting work on the workpiece is usually roughed out by a manual or low-precision cutting machine, and then finished by a finishing machine. The reason is that the manual processing and the ordinary processing machinery generally have low precision. Especially for the processing of large-volume workpieces with high precision requirements, finishing machines such as CNC machine tools and machining centers are indispensable. However, these finishing machines are often bulky, expensive, and complicated to operate. For individuals or factories that produce individual high-precision workpieces for small batches, it is obviously impractical to purchase a finishing machine that is expensive, bulky, and complicated to operate. Therefore, it is necessary to develop a miniaturized, intelligent, and high-precision hand-held milling device.

### SUMMARY OF THE INVENTION

The technical problem to be solved by the present invention is that in order to overcome the above problems, a handheld workpiece milling device with error self-correction based on augmented reality technology is provided, which has a reasonable structure, simple structure, convenient to use and high intelligence, high precision, small volume and strong practicability, and effectively solves the problem of low precision of the existing hand-held processing machine.

The technical solution adopted by the present invention to solve the technical problem by providing a handheld workpiece milling device with error self-correction based on augmented reality technology which includes a base, a control box, a milling mechanism, a control handle, a direction and distance detecting mechanism. One end of the base is provided with a transparent plate, and the other end of the base is provided with a through groove and a screw hole. A middle portion of the base is provided with a sliding groove, a groove body vertical to the sliding groove, and a support platform disposed on the groove body.

The sliding groove is an inverted T-shaped structure, and the sliding groove is respectively provided with I-shaped sliders. The I-shaped slider is fixedly provided with an electric cylinder, and the main shaft of the electric cylinder is fixedly connected with the side of the support platform. The bottom of the support platform is provided with a plurality of balls that are connected to the support platform.

The control box is disposed above the transparent plate. The controller, the battery and the display are arranged in the control box from bottom to top. The controller integrates a camera, and an illumination lamp. The camera and the illumination lamp face the transparent plate.

The milling mechanism is disposed in the middle portion of the base. The milling mechanism includes a housing, a motor disposed above the through groove, a rolling drum having a thread on the surface, and a support rod. The motor is fixedly disposed in the housing, and the main shaft of the motor is connected with an electromagnetic clutch, a chuck, and a milling cutter sequentially. The rolling drum and the electromagnetic clutch are mutually driven and connected by a transmission belt. The support rod is vertically disposed on the support platform. The housing is slidably connected to the support rod. The support rod is provided with a rack which is connected to the thread on the rolling drum.

The control handle is symmetrically fixedly disposed at two ends of the middle portion of the base, and the control handle is respectively provided with a plurality of control buttons. The direction and distance detecting mechanism includes a first [symbol] -shaped plate, an angle sensor, a tension spring, and a second [symbol] -shaped plate, and a roller.

One end of the first [symbol] -shaped plate is fixedly connected to the screw hole, and the angle sensor is fixedly disposed at the other end of the first [symbol] -shaped plate. The roller is disposed in the through groove, and the rotary encoder is disposed on the roller. One end of the second [symbol] -shaped plate is sleeved with the detecting end of the angle sensor, and the other end of the second [symbol] -shaped plate is connected with the rotary encoder. The tension spring is sleeved on the detecting end of the angle sensor. Two ends of the tension spring are respectively abutted against the second [symbol] -shaped plate and the angle sensor.

Further, the support platform is provided with a plurality of first distance sensors, and the detecting end of the first distance sensor faces the side wall of the groove body.

Further, the transparent plate is embedded in the base, and the upper and lower sides of the transparent plate are aligned with the upper and lower surfaces of the base.

Further, the chuck includes a spring collet interconnected with the main shaft of the motor, a magnetic sleeve sleeved in the inner cavity of the spring collet, and a locking nut threadedly connected to the spring collet.

Further, the magnetic sleeve includes a flexible plate, a plurality of magnetic curved plates fixedly disposed on the flexible plate. The milling cutter is sleeved in the inner cavity of the magnetic sleeve.

Further, the housing is provided with a second distance sensor.

Further, the controller is electrically connected to the electric cylinder, the battery, the display, the camera, the illumination lamp, the motor, the electromagnetic clutch, the control button, the angle sensor, the rotary encoder, the first distance sensor, and the second distance sensor, respectively.

The technical effect of the invention is to provide a handheld workpiece milling device with error self-correction based on augmented reality technology which includes a base, a control box, a milling mechanism, a control handle, and a direction and distance detecting mechanism. The base is closely attached to the workpiece processing surface. The controller automatically plans the route of travel or the operator manually plans the route by marking on the surface of the workpiece. The control handle is used to push the base along the planned route and send control commands to the controller, and the camera in the control box scans the surface of the workpiece and/or the direction and distance detecting mechanism uses the sensor to detect the error generated during the travel by measurement, and displays the planned road map and the workpiece surface in an overlapping manner to guide the traveling route, and the milling machine automatically controls the milling error to perform the milling operation on the workpiece. The handheld workpiece milling device with error self-correction based on augmented reality technology has a reasonable structure, simple structure, convenient to use and high intelligence, high precision, small volume and strong practicability, and effectively solves the problem of low precision of the existing hand-held processing machine.

### BRIEF DESCRIPTION OF THE DRAWINGS

The invention is illustrated by the following figures and embodiments.

FIG. 1 shows a schematic diagram of whole structure of a handheld workpiece milling device with error self-correction based on augmented reality technology in accordance with an example embodiment.

FIG. 2 shows a schematic diagram of the top view of a base of a handheld workpiece milling device with error self-correction based on augmented reality technology in accordance with an example embodiment.

FIG. 4 shows a schematic diagram of a base, a control box, and a control handle of a handheld workpiece milling device with error self-correction based on augmented reality technology in accordance with an example embodiment.

FIG. 5 shows a schematic diagram of connection of a control box and a base of a handheld workpiece milling device with error self-correction based on augmented reality technology in accordance with an example embodiment.

FIG. 6 shows a schematic diagram of milling mechanism of a handheld workpiece milling device with error self-correction based on augmented reality technology in accordance with an example embodiment.

FIG. 7 shows a schematic diagram of a chuck of a handheld workpiece milling device with error self-correction based on augmented reality technology in accordance with an example embodiment.

FIG. 8 shows a schematic diagram of a magnetic sleeve of a handheld workpiece milling device with error self-correction based on augmented reality technology in accordance with an example embodiment.

FIG. 9 shows a schematic diagram of connection of a direction and distance detecting mechanism and a base of a handheld workpiece milling device with error self-correction based on augmented reality technology in accordance with an example embodiment.

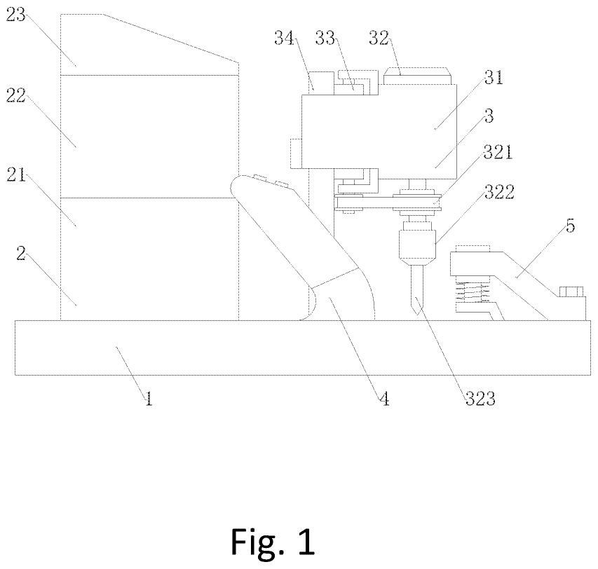

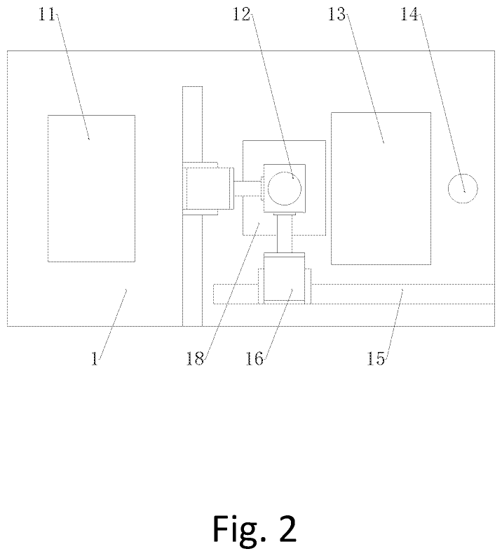

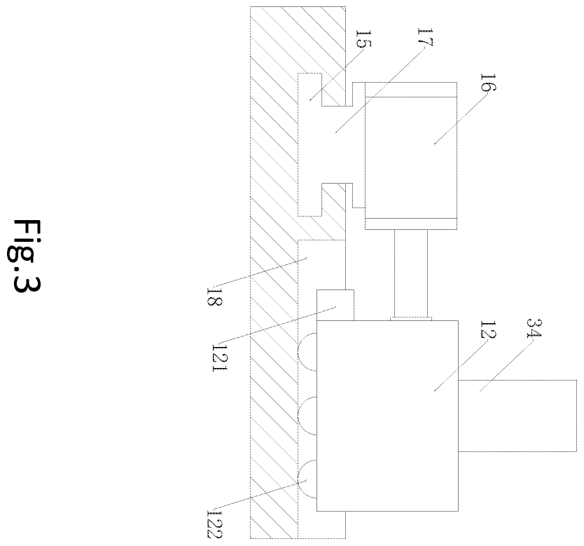

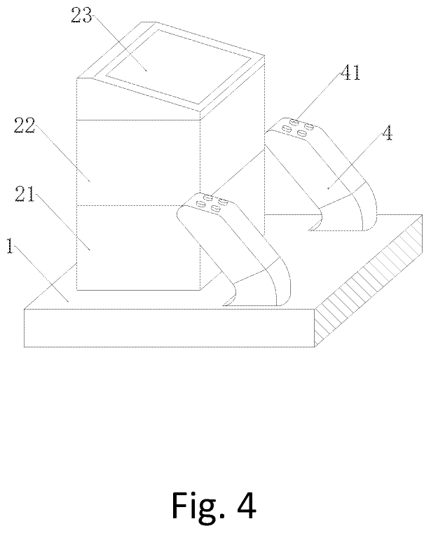

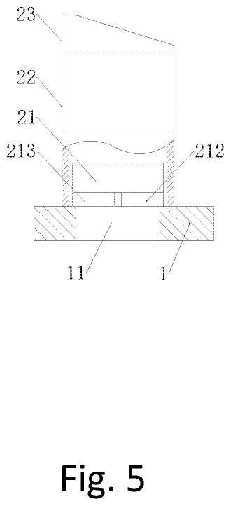

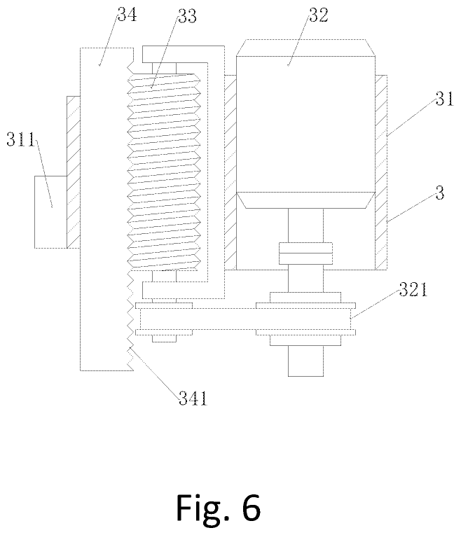

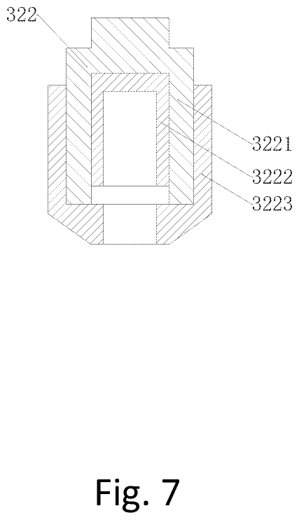

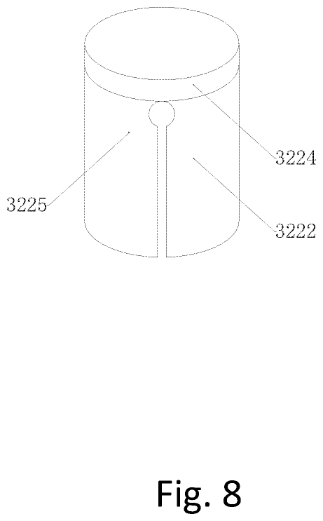

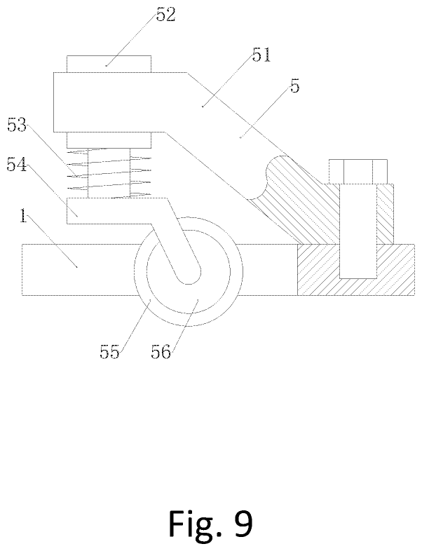

The reference numbers of the figures are as follows:
1: base; 11: transparent plate; 12: support platform; 121: first distance sensor; 122: ball; 13: through groove; 14: screw hole; 15: sliding groove; 16: electrical cylinder; 17: I-shaped slider; 18: groove body; 2: control box; 21: controller; 212: camera; 213: illumination lamp; 22: battery; 23: display; 3: milling mechanism; 31: housing; 311: second distance sensor; 32: motor; 321: electromagnetic clutch; 322: chuck; 3221: spring collet; 3222: magnetic sleeve; 3223: locking nut; 3224: flexible plate; 3225: magnetic curved plate; 323: milling cutter; 33: rolling drum; 34: support rod; 341: rack; 4: control handle; 41: control button; 5: direction and distance detecting mechanism; 51: first [symbol] -shaped plate; 52: angle detector; 53: tension spring; 54: first [symbol] -shaped plate; 55: roller; 56: rotatory encoder.

What is claimed is:

1. A handheld workpiece milling device with error self-correction based on augmented reality technology, comprising: a base 1, a control box 2, a milling mechanism 3, a control handle 4, and a direction and distance detecting mechanism 5, wherein one end of the base 1 is provided with a transparent plate 11, and the other end of the base 1 is provided with a through groove 13 and a screw hole 14; a middle portion of the base 1 is provided with a sliding groove 15, a groove body 18 vertical to the sliding groove 15, and a support platform 12 disposed on the groove body 18,
wherein the sliding groove 15 is an inverted T-shaped structure, and the sliding groove 15 is respectively provided with I-shaped sliders 17; the I-shaped slider 17 is fixedly provided with an electric cylinder 16, and the main shaft of the electric cylinder 16 is fixedly connected with the side of the support platform 12; the bottom of the support platform 12 is provided with a plurality of balls 122 that are connected to the support platform 12;
wherein the control box 2 is disposed above the transparent plate 11; the controller 21, the battery 22 and the display 23 are arranged in the control box 2 from bottom to top; the controller 21 integrates a camera 212, and an illumination lamp 213; the camera 212 and the illumination lamp 213 face the transparent plate 11,
wherein the milling mechanism 3 is disposed in the middle portion of the base; the milling mechanism 3 includes a housing 31, a motor 32 disposed above the through groove 13, a rolling drum 33 having a thread on the surface, and a support rod 34; the motor 32 is fixedly disposed in the housing 31, and the main shaft of the motor 32 is connected with an electromagnetic clutch 321, a chuck 322, and a milling cutter 323 sequentially; the rolling drum 33 is hinged to the housing 31; the rolling drum 33 and the electromagnetic clutch 321 are mutually driven and connected by a transmission belt; the housing 31 is slidably connected to the support rod 34; the support rod 34 is provided with a rack 341 which connects to the thread of the rolling drum 33,
wherein the control handle 4 is symmetrically fixedly disposed at two ends of the middle portion of the base 1, and the control handle 4 is respectively provided with a plurality of control buttons 41; the direction and distance detecting mechanism 5 includes a first [symbol] -shaped plate 51, an angle sensor 52, a tension spring 53, and a second [symbol] -shaped plate 54, and a roller 55,
wherein one end of the first [symbol] -shaped plate 51 is fixedly connected to the screw hole 14, and the angle sensor 52 is fixedly disposed at the other end of the first [symbol] -shaped plate 51; the roller 55 is disposed in the through groove 13, and the rotary encoder 56 is disposed on the roller 55; one end of the second [symbol] -shaped plate 54 is sleeved with the detecting end of the angle sensor 52, and the other end of the second [symbol] -shaped plate 54 is connected with the rotary encoder 56; the tension spring 53 is sleeved on the detecting end of the angle sensor 52; two ends of the tension spring 53 are respectively abutted against the second [symbol] -shaped plate 54 and the angle sensor 52.

2. The handheld workpiece milling device with error self-correction based on augmented reality technology of claim 1, wherein the support platform 12 is provided with a plurality of first distance sensors 121, and the detecting end of the first distance sensor 121 faces the side wall of the groove body 18.

3. The handheld workpiece milling device with error self-correction based on augmented reality technology of claim 1, wherein the transparent plate 11 is embedded in the base 1, and the upper and lower sides of the transparent plate 11 are aligned with the upper and lower surfaces of the base 1.

4. The handheld workpiece milling device with error self-correction based on augmented reality technology of claim 1, wherein the chuck 322 includes a spring collet 3221 interconnected with the main shaft of the motor 32, a magnetic sleeve 3222 sleeved in the inner cavity of the spring collet 3221, and a locking nut 3223 threadedly connected to the spring collet 3221.

5. The handheld workpiece milling device with error self-correction based on augmented reality technology of claim 4, wherein the magnetic sleeve 3222 includes a flexible plate 3224, a plurality of magnetic curved plates 3225 fixedly disposed on the flexible plate 3224; the milling cutter 323 is sleeved in the inner cavity of the magnetic sleeve 3222.

6. The handheld workpiece milling device with error self-correction based on augmented reality technology of claim 1, wherein the housing 31 is provided with a second distance sensor 311.

7. The handheld workpiece milling device with error self-correction based on augmented reality technology of claim 1, wherein the controller 21 is electrically connected to the electric cylinder 16, the battery 22, the display 23, the camera 212, the illumination lamp 213, the motor 32, the electromagnetic clutch 321, the control button 41, the angle sensor 52, the rotary encoder 56, the first distance sensor 121, and the second distance sensor 311, respectively.

8. The handheld workpiece milling device with error self-correction based on augmented reality technology of claim 2, wherein the controller 21 is electrically connected to the electric cylinder 16, the battery 22, the display 23, the camera 212, the illumination lamp 213, the motor 32, the electromagnetic clutch 321, the control button 41, the angle sensor 52, the rotary encoder 56, the first distance sensor 121, and the second distance sensor 311, respectively.

9. The handheld workpiece milling device with error self-correction based on augmented reality technology of claim 6, wherein the controller 21 is electrically connected to the electric cylinder 16, the battery 22, the display 23, the camera 212, the illumination lamp 213, the motor 32, the electromagnetic clutch 321, the control button 41, the angle sensor 52, the rotary encoder 56, the first distance sensor 121, and the second distance sensor 311, respectively.
